(19) United States
(12) Patent Application Publication
(10) Pub. No.: US 2025/0378429 A1
(43) Pub. Date: Dec. 11, 2025

(54) PAYMENT TERMINAL OPERATION SYSTEM, PAYMENT TERMINAL, AND INFORMATION PROCESSING APPARATUS

(71) Applicant: Toshiba Tec Kabushiki Kaisha, Tokyo (JP)

(72) Inventor: Hiroyasu AOKI, Izu Shizuoka (JP)

(21) Appl. No.: 19/048,330

(22) Filed: Feb. 7, 2025

(30) Foreign Application Priority Data
Jun. 5, 2024 (JP) 2024-091387

(51) Int. Cl. G06Q 20/20

(52) U.S. Cl. CPC G06Q 20/202; G06Q 20/209

(57) ABSTRACT

According to an embodiment, a payment terminal operation system includes an information processing apparatus and a payment terminal provided in a store. The information processing apparatus acquires, from the payment terminal, setting information that specifies a totaling item for totaling sales of transactions within a predetermined period. Further, the information processing apparatus generates sales data obtained by totaling the sales in the store in which the payment terminal is provided, on the basis of the acquired setting information, and transmits the generated sales data to the payment terminal. The payment terminal provides the setting information held by itself to the information processing apparatus and outputs the sales data received from the information processing apparatus.

### CROSS-REFERENCE TO RELATED APPLICATIONS

This application is based upon and claims the benefit of priority from the prior Japanese Patent Application No. 2024-91387, filed on Jun. 5, 2024, the entire contents of which are incorporated herein by reference.

### FIELD

Embodiments described herein generally relate to a payment terminal operation system, a payment terminal, and an information processing apparatus.

### BACKGROUND

From the past, retail stores have used payment terminals to execute payments relating to transactions. At the end of a business day, the payment terminal performs daily total processing to total the payments of that day. Further, some stores also perform sales report processing of transmitting the total information, as a sales report, to a credit center or the like after performing the daily total processing. The center feeds back the sales report to the shopping center, so that the shopping center can easily total the daily sales of each tenant.

However, since the sales report is an operation performed using the payment terminal, a person in charge of the sales report processing has to go to the location where the payment terminal is installed so as to execute the sales report processing at the end of the business day, which has been troublesome.

### BRIEF DESCRIPTION OF THE DRAWINGS

FIG. 1 is a block diagram showing an example of a payment system according to an embodiment.

FIG. 2 is a diagram showing an example of a hardware configuration of a payment terminal according to the embodiment.

FIG. 3 is a diagram showing an example of a sales report setting file according to the embodiment.

FIG. 4 is a diagram showing an example of a hardware configuration of a portable terminal according to the embodiment.

FIG. 5 is a diagram showing an example of functional configurations of the payment terminal and the portable terminal according to the embodiment.

FIG. 6 is a diagram showing an example of a sales report processing selection image according to the embodiment.

FIG. 7 is a diagram showing an example of a registration image according to the embodiment.

FIG. 8 is a diagram showing an example of an input image according to the embodiment.

FIG. 9 is a diagram showing an example of an input image according to the embodiment.

FIG. 10 is a diagram showing an example of an execution image according to the embodiment.

FIG. 11 is a diagram showing an example of an execution result image according to the embodiment.

FIG. 12 is a flowchart showing an example of transaction processing according to the embodiment.

FIG. 13 is a flowchart showing an example of daily total processing according to the embodiment.

FIG. 14 is a flowchart showing an example of remote sales report processing according to the embodiment.

### DETAILED DESCRIPTION

According to one embodiment, a payment terminal operation system includes a payment terminal and an information processing apparatus. The payment terminal is provided in a store and executes sales report processing of transmitting sales data obtained by totaling sales of the store to an external payment management system. The sales data is data of sales the store totaled for each predetermined totaling item. The information processing apparatus receives an input of the data of sales for each totaling item to remotely operate the sales report processing of the payment terminal. The payment terminal includes a first communication interface, a memory, and a first processor. The first communication interface executes communication with the information processing apparatus via a network. The memory stores setting information that specifies the totaling item. The first processor provides the setting information in the memory to the information processing apparatus via the first communication interface. The first processor receives the sales data totaled on the basis of the provided setting information from the information processing apparatus via the first communication interface. Further, the first processor outputs the received sales data to the payment management system via the first communication interface. The information processing apparatus includes a second communication interface and a second processor. The second communication interface executes communication with the payment terminal via the network. The second processor acquires the setting information from the payment terminal via the second communication interface. The second processor generates the sales data in the store in which the payment terminal is provided, on the basis of the setting information acquired from the payment terminal. Further, the second processor transmits the generated sales data to the payment terminal via the second communication interface.

Hereinafter, an embodiment of a payment terminal operation system, a payment terminal, and an information processing apparatus will be described in detail with reference to the drawings. Note that in the drawings the same reference symbols denote the same or similar portions. Further, an embodiment to be described below is an embodiment of a payment terminal operation system, a payment terminal, and an information processing apparatus and does not limit their configurations, specifications, and the like.

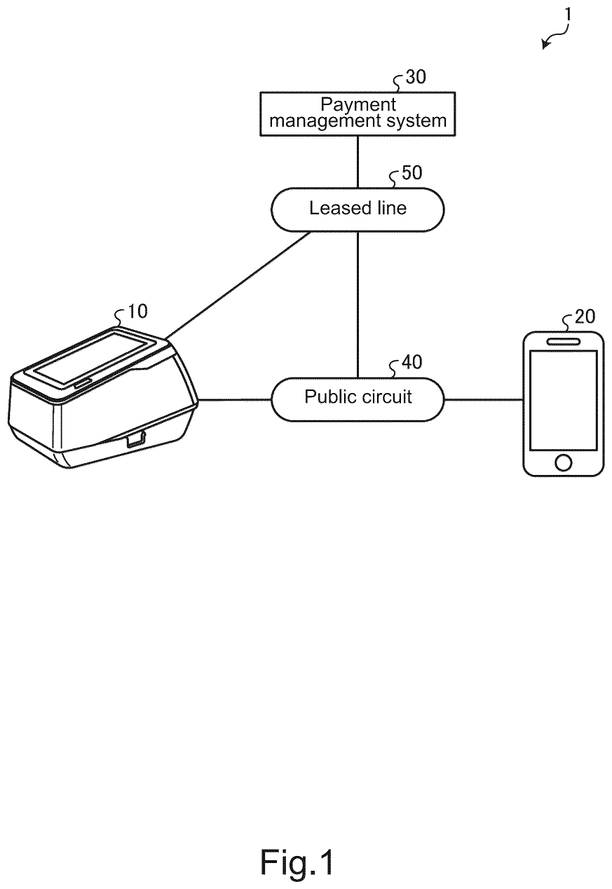

FIG. 1 is a block diagram showing an example of a payment system 1 according to this embodiment. The payment system 1 includes a payment terminal 10 and a portable terminal 20. The payment system 1 is connected to a payment management system 30 via a leased line 50. The payment system 1, including the payment terminal 10 that executes payments and the portable terminal 20 that operates the payment terminal 10, is an example of a payment terminal operation system.

The payment terminal 10 is connected to be communicable with the portable terminal 20 via a public circuit 40 such as the Internet. Further, the payment terminal 10 is connected to be communicable with the payment management system 30 via the leased line 50. In addition, the payment terminal 10 and the portable terminal 20 may be connected to be communicable with the payment management system 30 by virtually establishing a leased line in the public circuit 40 by a virtual private network (VPN).

Note that the payment system 1 shown in FIG. 1 is an example. In other words, the payment system 1 may include apparatuses or systems not shown in FIG. 1. In addition, the payment system 1 may include a plurality of payment terminals 10 or portable terminals 20.

The payment management system 30 includes a plurality of payment servers that manages payments by the payment terminal 10. For example, the payment management system 30 includes a credit center server that manages credit card payments, a voucher storage center that manages vouchers, a reward point provider server that manages reward points given in accordance with payments, an electronic money center server that manages electronic money payments, a maintenance server that distributes programs of the payment terminal 10, and the like.

Note that the payment management system 30 does not need to include all of those servers or may include servers other than those servers.

The payment terminal 10 is a device that executes payments in transactions. For example, the payment terminal 10 is a device that executes accounting processing by credit cards, electronic money, and the like. Further, the payment terminal 10 executes daily total processing of totaling the payments of the day. Furthermore, the payment terminal 10 may execute daily total processing through remote operation. Moreover, the payment terminal 10 executes sales report processing, which will be described later, through remote operation.

The portable terminal 20 is a portable device such as a smartphone or a tablet terminal. The portable terminal 20 is an example of an information processing apparatus. The portable terminal 20 causes the payment terminal 10 to execute sales report processing through remote operation.

Next, hardware configurations of the payment terminal 10 and the portable terminal 20 of the payment system 1 will be described.

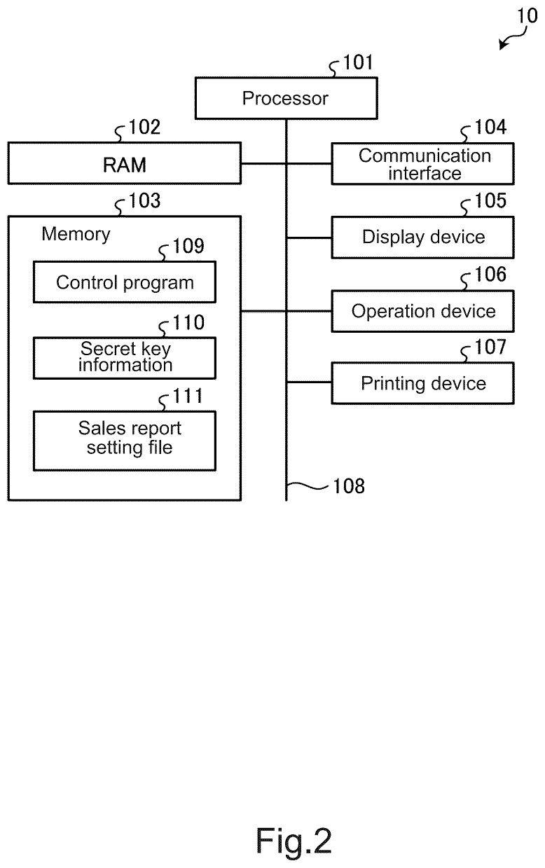

First, the hardware configuration of the payment terminal 10 will be described. FIG. 2 is a diagram showing an example of the hardware configuration of the payment terminal 10. The payment terminal 10 includes a processor 101, a random access memory (RAM) 102, a memory 103, a communication interface 104, a display device 105, an operation device 106, and a printing device 107. Those parts are mutually connected via a system bus 108 such as a data bus or an address bus.

The processor 101 is a processing circuit, such as a central processing unit (CPU), that controls the operation of the payment terminal 10. The RAM 102 is a storage medium that temporarily stores various programs and various types of data. The processor 101 also executes a control program 109 or the like stored in the memory 103, using the RAM 102 as a work area (workspace).

The memory 103 is a storage device such as a hard disk drive (HDD), a solid state drive (SSD), or a flash memory. The memory 103 stores the control program 109, secret key information 110, and a sales report setting file 111.

The control program 109 is the operating system or a program for implementing the functions of the payment terminal 10. The control program 109 includes a program for implementing characteristic functions according to this embodiment.

The secret key information 110 is a secret key of the payment terminal 10. More specifically, the secret key information 110 is information that is a key for decoding the information encrypted with a public key in a public-key cryptosystem.

The sales report setting file 111 is a setting file that specifies totaling items to be totaled as sales data, such as cash sales, the number of cases of cash sales, credit sales, the number of cases of credit sales, and the number of customers. The sales report setting file 111 is an example of the setting information.

A sales report is the totaled data obtained by totaling, for each totaling item, the sales data of transactions within a predetermined period. For example, the sales report is an aggregate of the sales data of transactions for one day at each store of a shopping center including multiple stores.

Here, what data (totaling item) is to be totaled differs from shopping center to shopping center. Thus, the sales report setting file 111 that specifies what data is to be totaled is stored in advance in the memory 103 of the payment terminal 10. This makes it possible to total the data requested by the shopping center to which the store where the payment terminal 10 is installed belongs.

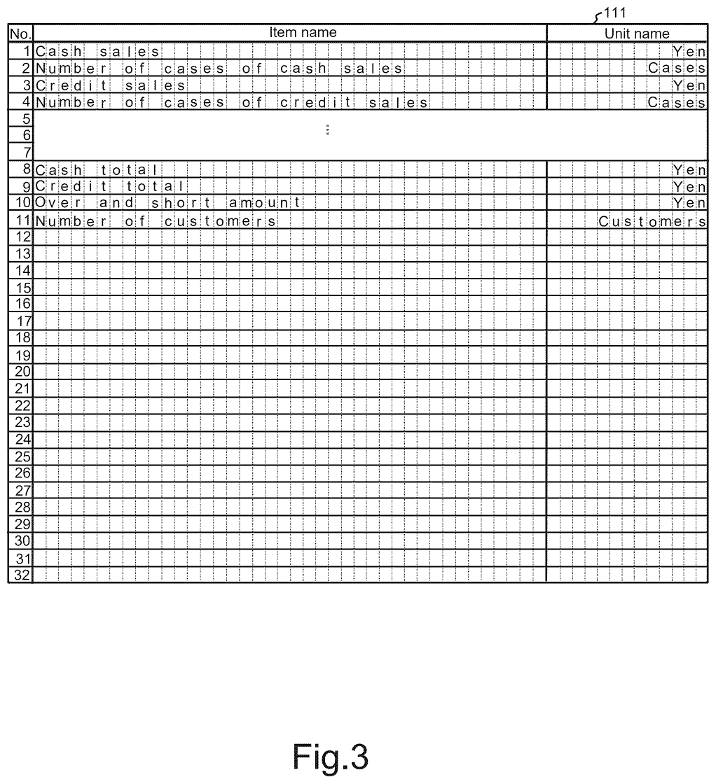

For example, the sales report setting file 111 stores the name of a totaling item and the unit of totaling item in association with each other. FIG. 3 is a diagram showing an example of the sales report setting file 111. The sales report setting file 111 of FIG. 3 stores “No.”, “Item name”, and “Unit name” in association with each other.

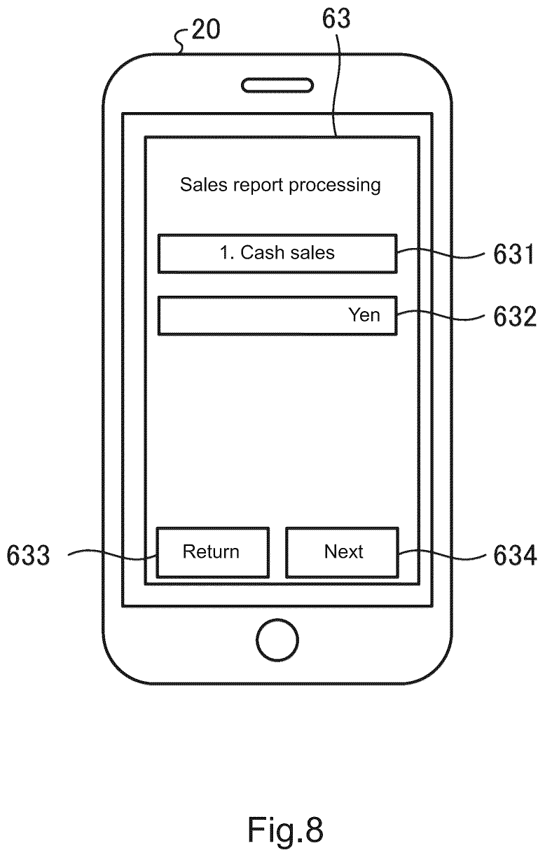

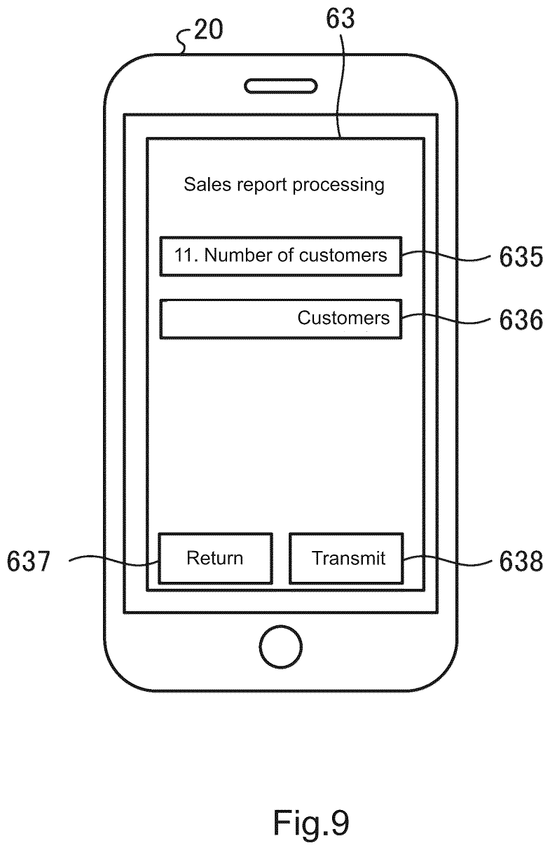

“No.” is information that specifies the display order of input images 63 of the sales data (see FIGS. 8 and 9). In the example of FIG. 3, “No. 1” represents that an input image 63 for inputting “cash sales” corresponding to “No. 1” is displayed first. Similarly, “No. 11” represents that an input image 63 for inputting “the number of customers” corresponding to “No. 11” is displayed last.

“Item name” is information indicating the name of an item. The item is an example of the totaling item. “Item name” is displayed in the input image 63. The user performs the operation of inputting the data corresponding to “Item name” displayed in the input image 63.

“Unit name” is information indicating the name of the unit of the item. “Unit name” is displayed in a data input field of the input image 63.

Returning to FIG. 2, the description is continued. The communication interface 104 is an interface that communicates with an external apparatus via a network. For example, the communication interface 104 is a network interface card (NIC).

The display device 105 is a display including a screen for displaying various images. For example, the display device 105 is a liquid crystal display.

The operation device 106 is an input device that accepts various operations. For example, the operation device 106 is a hardware button, a touch panel provided to the display device 105, or the like.

The printing device 107 prints on paper a receipt showing transaction contents, the state of reward points, and the like. Further, the printing device 107 prints on paper the processing results of the daily total processing. Furthermore, the printing device 107 prints on paper the processing results of the sales report processing.

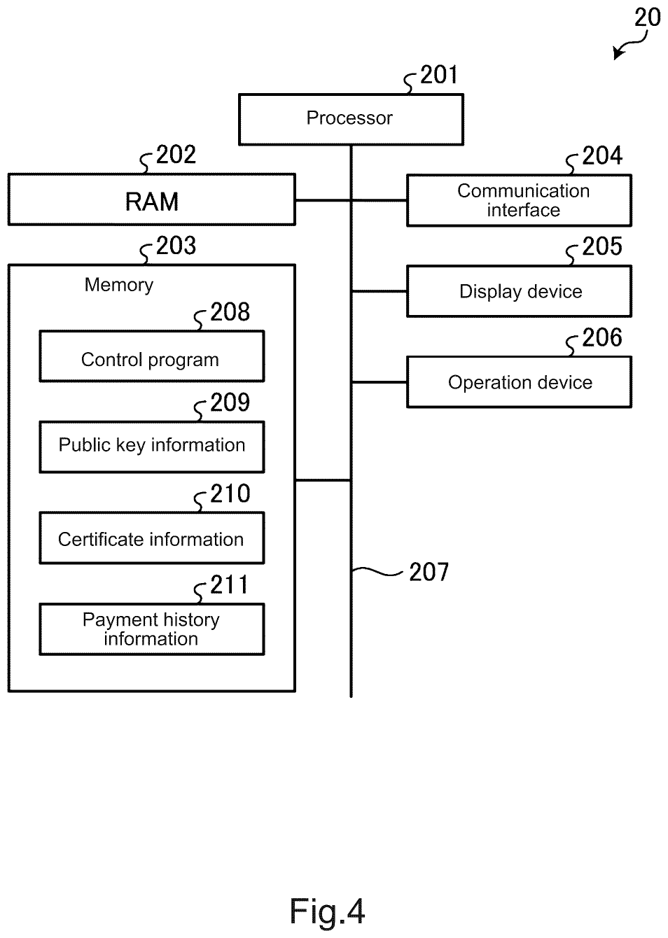

Next, the hardware configuration of the portable terminal 20 will be described. FIG. 4 is a diagram showing an example of the hardware configuration of the portable terminal 20. The portable terminal 20 includes a processor 201, a RAM 202, a memory 203, a communication interface 204, a display device 205, and an operation device 206. Those parts are mutually connected via a system bus 207 such as a data bus or an address bus.

The processor 201 is a processing circuit, such as a CPU, that controls the operation of the portable terminal 20. The RAM 202 is a storage medium that temporarily stores various programs and various types of data. The processor 201 also executes a control program 208 or the like stored in the memory 203, using the RAM 202 as a work area (workspace).

The memory 203 is a storage device such as an HDD, an SSD, or a flash memory. The memory 203 stores the control program 208, public key information 209, certificate information 210, and payment history information 211. Note that all or part of the public key information 209, the certificate information 210, and the payment history information 211 may be stored not only in the memory 203 but also in a storage medium of another apparatus.

The control program 208 is the operating system or a program for implementing the functions of the portable terminal 20. The control program 208 includes a program for implementing characteristic functions according to this embodiment.

The public key information 209 is a public key of the payment terminal 10. More specifically, the public key information 209 is information that is a key for encrypting information to be transmitted to the payment terminal 10 in the public-key cryptosystem. For example, the public key information 209 is used to encrypt the certificate information 210.

The certificate information 210 is information for certifying that the portable terminal 20 is registered. In other words, the certificate information 210 is information for certifying that the portable terminal 20 has an authority to execute daily total processing. The certificate information 210 includes authentication information, random number data, and expiration date information. The authentication information is information for identifying the authenticated portable terminal 20.

For example, the authentication information is identification information for identifying the portable terminal 20. Specifically, the authentication information is an internet protocol (IP) address or a media access control (MAC) address of the portable terminal 20. Further, the authentication information may be information indicating that the operator who operates the portable terminal 20 is an authenticated user. The random number data is data of a random number. The random number data is used to generate a communication key that is used for communication between the payment terminal 10 and the portable terminal 20. The expiration date information is information indicating an expiration date of the certificate information 210.

The payment history information 211 is the history of payment contents such as a credit payment and an electronic money payment. The payment history information 211 includes payment date-and-time information and payment contents information. The payment date-and-time information is information indicating the date and time when the payment such as a credit payment or an electronic money payment has been executed. The payment contents information is information indicating payment contents.

For example, the payment contents information includes payment business operator identification information, transaction contents information, payment method information, and the like. The payment business operator identification information is identification information for identifying a payment business operator who performs business for a credit payment, an electronic money payment, or the like. The transaction contents information is information on the amount of sales indicating that the payment has been received and the amount of cancel/return indicating that the payment has been returned. The payment method information is information of a payment method, such as a lump-sum payment, a payment by bonus, or a payment by installments, from the customer to the payment business operator.

The communication interface 204 is an interface that communicates with an external apparatus via a network. For example, the communication interface 204 is a NIC. The display device 205 is a display including a screen for displaying various images. For example, the display device 205 is a liquid crystal display.

The operation device 206 is an input device that accepts various operations. For example, the operation device 206 is a hardware button, a touch panel provided to the display device 205, or the like.

Next, the functions of the payment terminal 10 will be described.

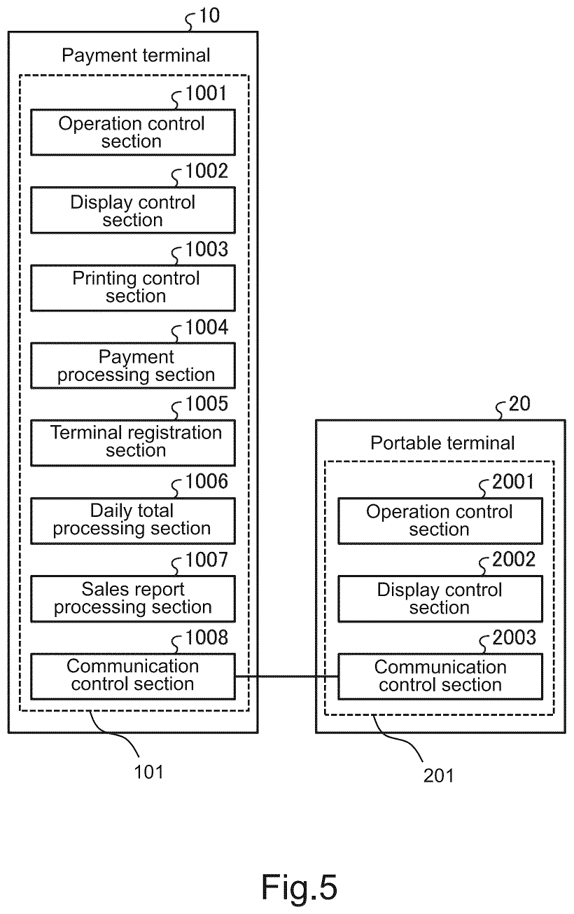

FIG. 5 is a block diagram showing an example of functional configurations of the payment terminal 10 and the portable terminal 20. The processor 101 of the payment terminal 10 expands the control program 109, which is stored in the memory 103, into the RAM 102 and operates according to the control program 109, to thereby generate functional sections in the RAM 102.

Thus, the processor 101 of the payment terminal 10 includes, as functional sections, an operation control section 1001, a display control section 1002, a printing control section 1003, a payment processing section 1004, a terminal registration section 1005, a daily total processing section 1006, a sales report processing section 1007, and a communication control section 1008.

The operation control section 1001 controls the operation device 106 to accept various operations. For example, the operation control section 1001 accepts an operation relating to the payment processing or an operation relating to the daily total processing.

The display control section 1002 displays various images on the display device 105. For example, the display control section 1002 displays an image relating to the payment processing or an image relating to the daily total processing.

The printing control section 1003 controls the printing device 107 to print various types of information. For example, the printing control section 1003 prints a receipt relating to one transaction by the payment processing. The receipt includes information relating to the payment processing. For example, the receipt includes information relating to a payment business operator, a payment method such as a lump-sum payment, a payment by bonus, or a payment by installments, the amount of money, and the like.

Further, the printing control section 1003 prints payment processing results of the payment processing executed by the payment processing section 1004 on paper such as a receipt.

The payment processing section 1004 executes a payment through communication with the payment server of the payment management system 30. For example, the payment processing section 1004 executes a credit payment or an electronic money payment through the communication with the payment server.

Further, when the payment processing section 1004 executes a payment such as a credit payment or an electronic money payment, the payment processing section 1004 associates the payment date-and-time information indicating the date and time at which the payment has been made, with the payment contents information indicating payment contents, thereby registering them in the payment history information 211.

The terminal registration section 1005 registers the portable terminal 20 that gives instruction to execute the sales report processing. In other words, the terminal registration section 1005 registers information relating to the portable terminal 20 having an authority to cause the payment terminal 10 to execute the sales report processing.

For example, the information relating to the portable terminal 20 includes identification information for identifying the portable terminal 20 requested to be authenticated, and a public key of the portable terminal 20 in the public-key cryptosystem. For example, the identification information may be an IP address of the portable terminal 20, and a MAC address or other identification information may be registered.

More specifically, when the communication control section 1008 receives a registration command, the terminal registration section 1005 registers the portable terminal 20 identified by the information relating to the portable terminal 20 included in the registration command. In other words, the terminal registration section 1005 registers the identification information for identifying the portable terminal 20, and the public key. Thus, the terminal registration section 1005 registers the portable terminal 20 having an authority to cause the payment terminal 10 to execute the daily total processing.

The daily total processing section 1006 executes the daily total processing of totaling the payments executed within a specified period by the payment processing section 1004. More specifically, the daily total processing section 1006 executes the daily total processing of totaling the payments of the day, to which transactions in which the payment processing is executed belong, on the basis of the payment history information 211.

Note that the specified period is any period. For example, the specified period may be a day on which time for executing the daily total processing belongs, may be time from a first designated time to a second designated time, or may be another period. In addition, the specified period may be a period including a plurality of days, such as one week or one month.

Here, the daily total processing is processing of totaling the payments executed by the payment processing section 1004 within a specified period on a payment business operator basis. The daily total processing is typically performed at the end of a business day. Further, the daily total processing includes daily total processing with detailed settings and daily total] processing with summary settings.

The daily total processing with detailed settings is the processing of totaling the details of the payment in each transaction. When the daily total processing section 1006 executes the daily total processing with detailed settings, the daily total processing section 1006 outputs daily total processing results in which the details of the payment in each transaction are arranged.

The daily total processing with summary settings outputs daily total processing results including the summary for each payment method by which the customer pays to the payment business operator, in the payment in each transaction. For example, the daily total processing results include: sales indicating that the payment has been received; and cancel/return indicating that the payment has been returned. The daily total processing section 1006 totals the number of cases and the amounts of money for each payment method such as a lump-sum payment, a payment by bonus, or a payment by installments, for each of the sales and the cancel/return.

The daily total processing section 1006 outputs the daily total processing results generated by the daily total processing. For example, the daily total processing section 1006 outputs the daily total processing results by causing the communication control section 1008 to transmit those results or causing the printing control section 1003 to print those results.

The sales report processing section 1007 executes the sales report processing of totaling the sales data. More specifically, the sales report processing section 1007 executes the sales report processing of totaling the sales data including the totaling items specified by the sales report setting file on the day, to which a transaction in which the payment processing is executed belongs, in accordance with the input of the user.

The sales report processing section 1007 outputs sales report processing results. For example, the sales report processing section 1007 outputs sales report processing results by causing the communication control section 1008 to transmit those results or causing the printing control section 1003 to print those results. In this case, the sales report processing section 1007 is an example of a first output section.

The communication control section 1008 controls the communication interface 104 to communicate with an external apparatus. For example, the communication control section 1008 communicates with the payment management system 30 via the leased line 50. More specifically, the communication control section 1008 executes communication relating to a payment with the payment server of the payment management system 30.

For example, the communication control section 1008 executes communication with the portable terminal 20 via the public circuit 40. More specifically, the communication control section 1008 executes communication with the portable terminal 20 by the public-key cryptosystem. In other words, the communication control section 1008 executes communication when the portable terminal 20 is authenticated by the certificate information 210.

For example, the communication control section 1008 receives from the portable terminal 20 a registration command to register the portable terminal 20 having an authority to cause the payment terminal 10 to execute the sales report processing. Further, for example, the communication control section 1008 receives from the portable terminal 20 a sales report setting file acquisition command to request the transmission of a sales report setting file. Furthermore, for example, the communication control section 1008 receives the sales data from the portable terminal 20.

Further, for example, the communication control section 1008 transmits the sales report setting file 111 to the portable terminal 20. In this case, the communication control section 1008 is an example of a providing section. Furthermore, for example, the communication control section 1008 transmits the sales data to the credit center server of the payment management system 30. In this case, the communication control section 1008 is an example of the first output section. Moreover, for example, the communication control section 1008 transmits execution results of the sales report processing to the portable terminal 20.

Next, the functions of the portable terminal 20 will be described.

The processor 201 of the portable terminal 20 expands the control program 208, which is stored in the memory 203, into the RAM 202 and operates according to the control program 208, to thereby generate functional sections in the RAM 202. Thus, the processor 201 of the portable terminal 20 includes, as functional sections, an operation control section 2001, a display control section 2002, and a communication control section 2003.

The operation control section 2001 accepts various operations from the operation device 206. For example, the operation control section 2001 accepts an operation relating to the daily total processing of the payment terminal 10.

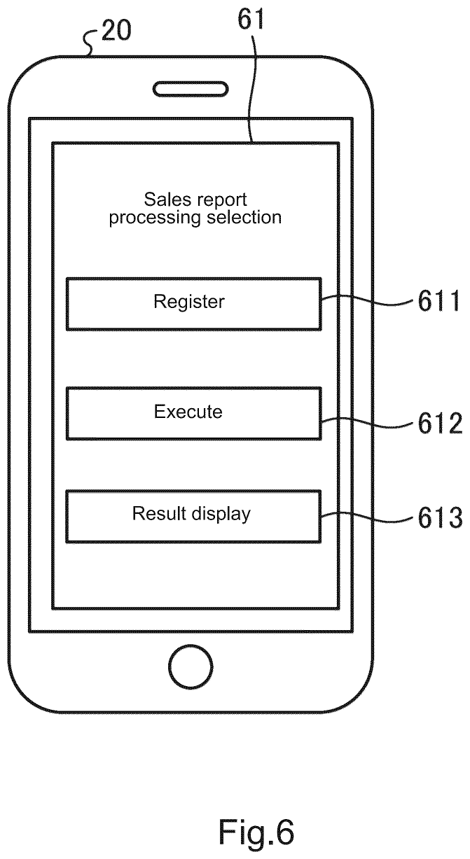

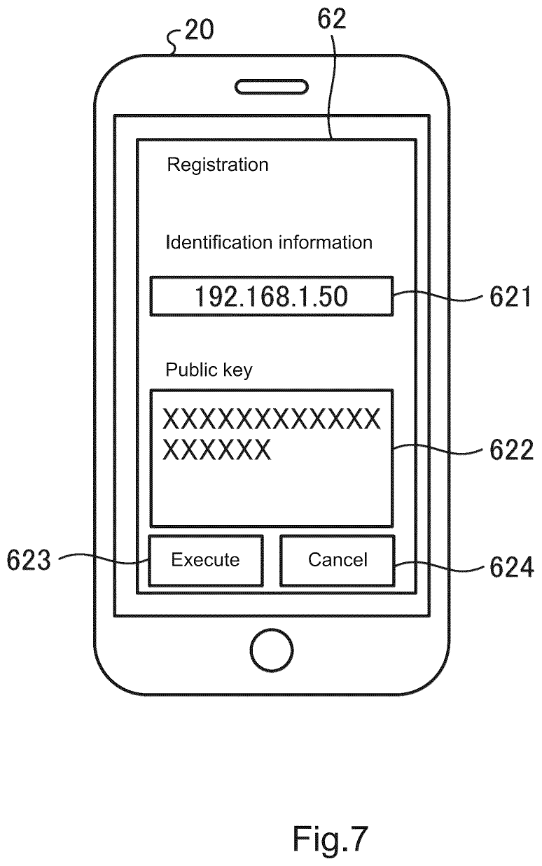

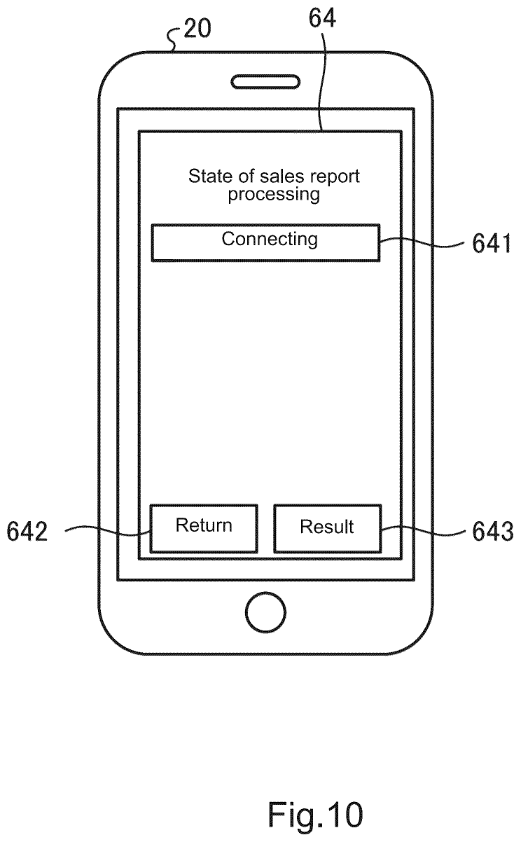

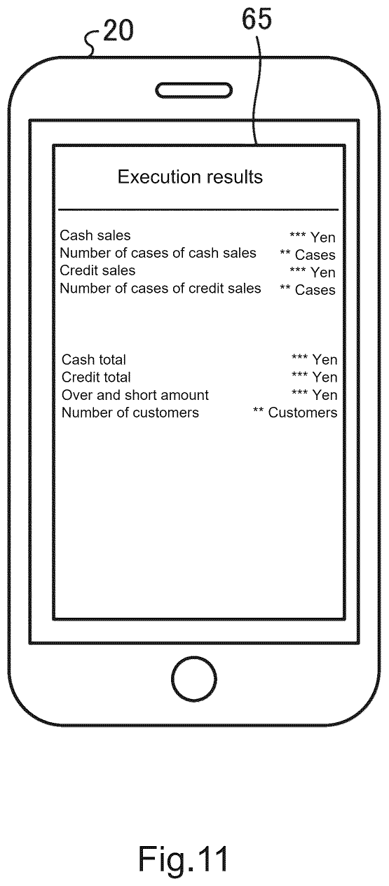

The display control section 2002 displays various images on the display device 205. For example, the display control section 2002 controls generation and display of images relating to the sales report processing, such as a sales report processing selection image 61 (see FIG. 6), a registration image 62 (see FIG. 7), input images 63, an execution image 64 (see FIG. 10), and an execution result image 65 (see FIG. 11).

FIG. 6 is a diagram showing an example of the sales report processing selection image 61. The sales report processing selection image 61 is an image for accepting a selection of a function to be executed by the portable terminal 20, among the functions relating to the sales report processing that can be executed by the portable terminal 20. The sales report processing selection image 61 includes a registration button 611, an execution button 612, and a result display button 613.

The registration button 611 is a button for accepting the operation of displaying the registration image 62 on which the portable terminal 20 having an authority to execute the sales report processing is to be registered.

The execution button 612 is a button for accepting the operation of executing the sales report processing. The execution button 612 is also a button for accepting the operation of displaying an input image 63 on which the data input of totaling items is to be accepted. In other words, the operation control section 2001 accepts the operation of starting the input of the sales data when the execution button 612 is pressed.

The result display button 613 is a button for accepting the operation of displaying the execution result image 65 including execution results of the sales report processing.

FIG. 7 is a diagram showing an example of the registration image 62. The registration image 62 is an image for registering information relating to the portable terminal 20 having an authority to execute the sales report processing. The registration image 62 includes an identification information input field 621, a public key input field 622, an execution button 623, and a cancel button 624.

The identification information input field 621 is a field to which the identification information for identifying the portable terminal 20 is input. In other words, the identification information input field 621 is a field to which the identification information for identifying the portable terminal 20 requested to be authenticated is input.

The public key input field 622 is a field to which the public key of the portable terminal 20 is input. The execution button 623 is a button for accepting the operation of registering the identification information input to the identification information input field 621 and the public key input to the public key input field 622. In such a manner, the operation control section 2001 accepts the information relating to the portable terminal 20 having an authority to cause the payment terminal 10 to execute the sales report processing.

When the execution button 623 is pressed, the communication control section 2003 transmits to the payment terminal 10 a registration command including the identification information input to the identification information input field 621 and the public key input to the public key input field 622.

The terminal registration section 1005 of the payment terminal 10 registers the identification information and public key included in the registration command. Thus, the portable terminal 20 is registered as the portable terminal 20 having an authority to execute the sales report processing. The cancel button 624 is a button for accepting the operation of cancelling the registration of the identification information input to the identification information input field 621 and the public key input to the public key input field 622.

FIGS. 8 and 9 are diagrams each showing an example of the input image 63. The input image 63 is an image generated in accordance with the sales report setting file 111.

For example, in the case of following the sales report setting file 111 of FIG. 3, the input image 63 is an image for inputting the data corresponding to the totaling items of “1. Cash sales”, “2. Number of cases of cash sales”, “3. Credit sales”, “4. Number of cases of credit sales”, . . . “8. Cash total”, “9. Credit total”, “10. Over and short amount”, and “11. Number of customers”.

FIG. 8 is an example of an image displayed first as the input image 63. The input image 63 of FIG. 8 includes an item name display field 631, a data input field 632, a return button 633, and a next button 634.

The item name display field 631 is a field in which the information representing “No.” of the sales report setting file 111 and the information representing “item name (name of totaling item)” are displayed. In the input image 63 of FIG. 8, which corresponds to “No. 1” of the sales report setting file 111 of FIG. 3, the item name display field 631 is displayed as “1. Cash sales”.

The data input field 632 is an input field for the user to input the data corresponding to the item name display field 631, in which information representing “unit name” of the sales report setting file 111 is displayed.

In the input image 63 of FIG. 8, which corresponds to “No. 1” of the sales report setting file 111 of FIG. 3, the data input field 632 displays Yen that is “unit name” corresponding to “cash sales”.

For example, the user touches the data input field 632 to input the data corresponding to the item name display field 631. In other words, the operation control section 2001 accepts an input of the data corresponding to the item indicated by the item name display field 631 via the data input field 632.

The return button 633 is a button for accepting the operation of displaying the sales report processing selection image 61. The next button 634 is a button for accepting the operation of displaying an input image 63 of the next item. In the example of FIG. 8, the operation control section 2001 accepts the operation of displaying an input image 63 for inputting “2. Number of cases of cash sales” by the press of the next button 634.

Note that the display control section 2002 may display the next button 634 to be grayed out such that the next button 634 is impossible to press when no numerical values are input to the data input field 632. This makes it possible to prevent data input omissions.

FIG. 9 is an example of an image displayed last as the input image 63. The input image 63 of FIG. 9 includes an item name display field 635, a data input field 636, a return button 637, and a transmission button 638. The item name display field 635 and the data input field 636 are the same as the item name display field 631 and the data input field 632, and thus description thereof will be omitted.

The return button 637 is a button for accepting the operation of displaying the input image 63 of the previous item. In the example of FIG. 9, the operation control section 2001 accepts the operation of displaying an input image 63 for inputting “10. Over and short amount” by the press of the return button 637. Thus, for example, when the user finds an input error in the data corresponding to the item that has already been input, the input image 63 of the item for which the user has made an input error can be displayed again.

The transmission button 638 is a button for accepting the operation of transmitting the sales data to the credit center server of the payment management system 30. In other words, the transmission button 638 is a button for accepting the operation of displaying the execution image 64.

In the example of FIG. 9, the operation control section 2001 accepts the operation of causing the payment terminal 10 to transmit the sales data to the credit center server of the payment management system 30 by the press of the transmission button 638. Further, the display control section 2002 displays the execution image 64.

FIG. 10 is a diagram showing an example of the execution image 64. The execution image 64 is an image a showing a state of the sales report processing. The execution image 64 includes a state display field 641, a return button 642, and a result button 643.

The state display field 641 is a field in which the state of the sales report processing is displayed. For example, the state display field 641 is field in which the state of the sales report processing, such as connecting, performing authentication processing, transmitting command, receiving data, normal completion, or error, is displayed. Further, in the case of error, the state display field 641 displays an error code for identifying the contents of error.

The display control section 2002 displays the state of the sales report processing in the state display field 641 on the basis of a communication log of the communication control section 2003. In other words, the display control section 2002 displays in the state display field 641 the state of the sales report processing identified on the basis of the communication contents indicated by the communication log.

The return button 642 is a button for accepting the operation of displaying the sales report processing selection image 61. The result button 643 is a button for accepting the operation of displaying execution results of the sales report processing. In other words, the result button 643 is a button for accepting the operation of displaying the execution result image 65.

FIG. 11 is a diagram showing an example of the execution result image 65. The execution result image 65 is an image including sales report processing results. In other words, the display control section 2002 displays the processing results of the sales report processing on the display device 205. The sales report processing results shown in FIG. 11 represent the contents of the sales data transmitted by the payment terminal 10 to the credit center server of the payment management system 30.

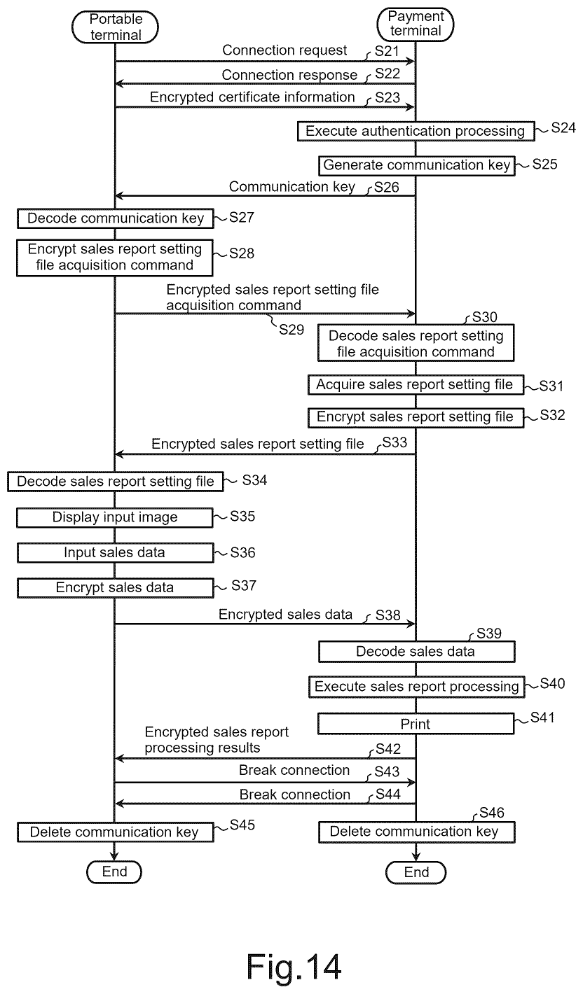

The communication control section 2003 controls the communication interface 204 to execute communication with an external apparatus. For example, the communication control section 2003 executes communication with the payment terminal 10 via the public circuit 40. More specifically, the communication control section 2003 executes communication with the payment terminal 10 by the public-key cryptosystem. For example, when the operation control section 2001 accepts the operation of executing the sales report processing by the press of the execution button 612 of the sales report processing selection image 61 (see the execution button 612 of FIG. 6), the communication control section 2003 requests authentication by transmitting the certificate information 210 to the payment terminal 10 (see Step S23 of FIG. 14 to be described later). When authentication is performed by the payment terminal 10, the communication control section 2003 transmits a sales report setting file acquisition command that requests a sales report setting file (see Step S29 of FIG. 14 to be described later).

The communication control section 1008 of the payment terminal 10, which has received the sales report setting file acquisition command, acquires the sales report setting file 111 from the memory 103 (see Step S31 of FIG. 14 to be described later). The communication control section 1008 encrypts the acquired sales report setting file 111 with the communication key and transmits the encrypted sales report setting file 111 to the portable terminal 20 (see Step S33 of FIG. 14). The communication control section 2003 of the portable terminal 20 receives the encrypted sales report setting file 111 from the payment terminal 10. In this case, the communication control section 2003 is an example of a first acquisition section.

Further, for example, when the operation control section 2001 accepts the operation of causing the payment terminal 10 to transmit the sales data to the credit center server of the payment management system 30 (see the transmission button 638 of FIG. 9), the communication control section 2003 transmits the sales data encrypted with the communication key to the payment terminal 10 (see Step S38 of FIG. 14). In this case, the communication control section 2003 is an example of a transmission section and second output section.

Specifically, the communication control section 2003 transmits each piece of the data corresponding to the items (totaling items) indicated by the item name display field, the data being input via the plurality of input images 63, as sales data, to the payment terminal 10. It also means that the communication control section 2003 in this case generates sales data from the contents input via the input images 63 based on the sales report setting file 111. Hence, in this case, the communication control section 2003 can be an example of a generation section.

Note that the display control section 2002 may display the contents of the sales data on the display device 205 before the sales data is transmitted to the payment terminal 10. In this case, the display control section 2002 is an example of the second output section. Displaying the contents of the sales data before being transmitted makes it possible for the user to confirm whether or not there are data input omissions, for example.

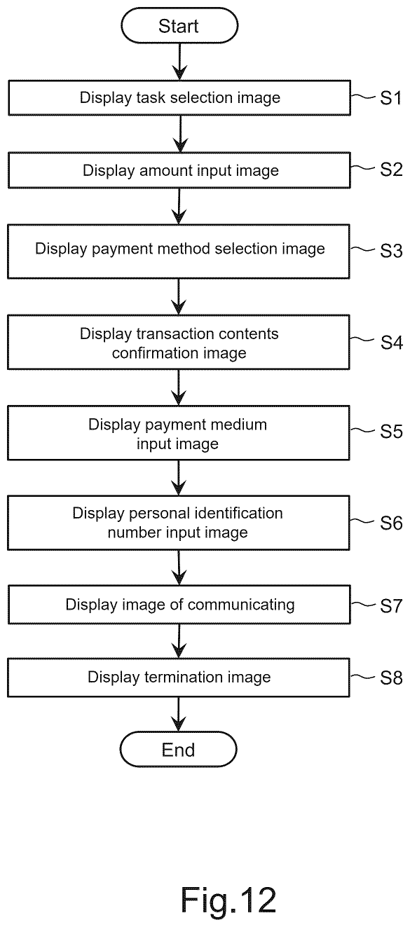

Next, the transaction processing executed by the payment terminal 10 will be described. FIG. 12 is a flowchart showing an example of the transaction processing according to this embodiment.

The display control section 1002 displays a task selection image for selecting a task performed by a user who operates the payment terminal 10 (Step S1). The operation control section 1001 accepts the operation of selecting the payment processing on the task selection image.

The display control section 1002 displays an amount input image for accepting the amount of payment (Step S2). The operation control section 1001 accepts an input for specifying the amount of payment.

The display control section 1002 displays a payment method selection image for accepting the selection of a payment method by which the customer makes a payment to the payment business operator (Step S3). The operation control section 1001 accepts an input for specifying the payment method.

The display control section 1002 displays a transaction contents confirmation image including the list of transaction contents, such as products and services, subject to the payment processing (Step S4). The operation control section 1001 accepts the operation indicating that the list of transaction contents has been confirmed.

The display control section 1002 displays a payment medium input image for prompting the user to input information held by a payment medium, such as a card, to the payment terminal 10 (Step S5).

The display control section 1002 displays a personal identification number input image for accepting the input of a personal identification number of the payment medium (Step S6). The operation control section 1001 accepts the input of the personal identification number.

The display control section 1002 displays an image of “communicating”, which indicates that communication with the payment server of the payment management system 30 is being performed (Step S7).

The display control section 1002 displays a termination image indicating that the communication with the payment server of the payment management system 30 is terminated (Step S8).

Through the above processing, the payment terminal 10 terminates the transaction processing.

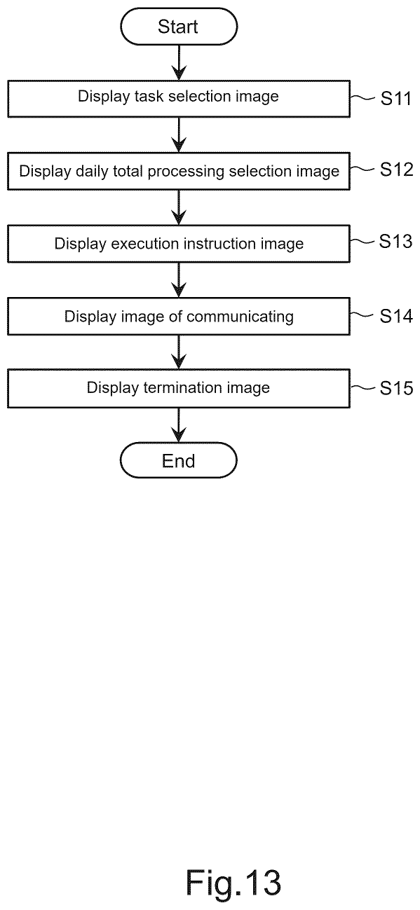

Next, the daily total processing executed by the payment terminal 10 will be described. FIG. 13 is a flowchart showing an example of the daily total processing according to this embodiment.

The display control section 1002 displays a task selection image for selecting a task performed by a user who operates the payment terminal 10 (Step S11). The operation control section 1001 accepts the operation of selecting the daily total processing in which payments executed within a specified period are totaled, on the task selection image.

The display control section 1002 displays a daily total processing selection image for prompting the user who operates the payment terminal 10 to select the type of daily total processing to be executed (Step S12). The operation control section 1001 accepts an input for specifying detailed settings or summary settings via the daily total processing selection image.

The display control section 1002 displays an execution instruction image for prompting the user who operates the payment terminal 10 to input the operation to instruct the execution of the daily total processing (Step S13). The operation control section 1001 accepts the input of the instruction to execute the daily total processing via the execution instruction image.

The display control section 1002 displays an image of “communicating”, which indicates that communication with the credit center server of the payment management system 30 is being performed (Step S14).

The display control section 1002 displays a termination image indicating that the communication with the credit center server of the payment management system 30 is terminated (Step S15).

Through the above processing, the payment terminal 10 terminates the daily total processing.

Next, the sales report processing executed by the payment terminal 10 and the portable terminal 20 will be described. FIG. 14 is a flowchart showing an example of remote sales report processing according to the embodiment.

The sales report processing is processing executed when the execution button 612 of the sales report processing selection image 61 (see FIG. 6) is pressed. The display control section 2002 of the portable terminal 20 then displays the state of the sales report processing in the state display field 641 of the execution image 64 on the basis of the communication log of the communication via the public circuit 40 in the remote sales report processing (see FIG. 10).

The communication control section 2003 of the portable terminal 20 transmits a connection request for requesting the connection with the portable terminal 20 to the payment terminal 10 (Step S21). For example, the communication control section 2003 transmits a connection request for requesting the connection by the transmission control protocol (TCP).

The communication control section 1008 of the payment terminal 10 transmits to the portable terminal 20 a connection response for replying that the connection is provided in response to the connection request (Step S22).

The communication control section 2003 of the portable terminal 20 transmits to the payment terminal 10 the certificate information 210 encrypted with the public key information 209 that is a public key of the payment terminal 10 (Step S23).

The communication control section 1008 of the payment terminal 10 executes the authentication processing for the portable terminal 20 on the basis of the received certificate information 210 (Step S24). The communication control section 1008 determines whether or not the expiration date of the certificate information 210 has passed on the basis of the expiration date information included in the certificate information 210 decoded with the secret key of the payment terminal 10.

Further, the communication control section 1008 compares the authentication information included in the certificate information 210 decoded with the secret key of the payment terminal 10 with the authentication information identified by the terminal registration section 1005, to determine whether or not the portable terminal 20 has been registered. The communication control section 1008 breaks the connection if the portable terminal 20 is not authenticated. The payment terminal 10 then terminates the remote sales report processing.

The communication control section 1008 generates a communication key from the random number data included in the certificate information 210 if the portable terminal 20 is authenticated (Step S25).

The communication control section 1008 transmits the communication key encrypted with the secret key of the payment terminal 10 to the portable terminal 20 (Step S26).

The communication control section 2003 of the portable terminal 20 decodes the encrypted communication key with the public key of the payment terminal 10 (Step S27).

The communication control section 2003 encrypts a sales report setting file acquisition command with the decoded communication key (Step S28). The communication control section 2003 transmits the encrypted sales report setting file acquisition command to the payment terminal 10 (Step S29).

The communication control section 1008 of the payment terminal 10 executes the authentication processing for the received sales report setting file acquisition command (Step S30). For example, the communication control section authenticates the sales report setting file acquisition command if the received sales report setting file acquisition command can be decoded with the communication key. In other words, the communication control section 1008 In authenticates the portable terminal 20 that has transmitted the sales report setting file acquisition command.

The communication control section 1008 acquires the sales report setting file 111 (Step S31). For example, the communication control section 1008 acquires the sales report setting file 111 stored in the memory 103. The communication control section 1008 encrypts the acquired sales report setting file 111 with the communication key (Step S32). The communication control section 1008 transmits the encrypted sales report setting file 111 to the portable terminal 20 (Step S33).

The communication control section 2003 of the portable terminal 20 decodes the received encrypted sales report setting file 111 with the communication key (Step S34). The display control section 2002 displays the input image 63 for accepting the input of the sales data in accordance with the decoded sales report setting file 111 (Step S35). For example, the display control section 2002 displays the input image 63 shown in FIG. 8.

The operation control section 2001 accepts the input of the sales data (Step S36). For example, the operation control section 2001 accepts the input of the data corresponding to “1. Cash sales” of the item name display field 631 from the user via the data input field 632 of the input image 63. After that, the operation control section 2001 accepts the input to press the next button 634 from the user. Next, the display control section 2002 displays the input image 63 of the next item.

Subsequently, the display of the input image 63 by the display control section 2002, and the reception of the input of the data corresponding to the item by the operation control section 2001 are repeated to accept the input of the data corresponding to all the items specified by the sales report setting file 111. After the input of the data corresponding to all the items is accepted, the communication control section 2003 sets each piece of the input data corresponding to the items as sales data. The communication control section 2003 encrypts the sales data with the communication key (Step S37).

The communication control section 2003 transmits the encrypted sales data to the payment terminal 10 (Step S38). The communication control section 1008 of the payment terminal 10 decodes the received encrypted sales data with the communication key (Step S39).

The sales report processing section 1007 of the payment terminal 10 executes the sales report processing (Step S40). For example, the sales report processing section 1007 causes the communication control section 1008 to transmit the decoded sales data to the credit center server of the payment management system 30. When the sales report processing section 1007 is executing the sales report processing, the display control section 1002 may display an image indicating that the sales report processing is being executed.

The printing control section 1003 prints processing results of the sales report processing under the control of the sales report processing section 1007 (Step S41). During printing of the processing results, the display control section 1002 may display an image indicating that the processing results are being printed. Further, during the execution of the sales report processing or printing, operation control section 1001 may accept no operations.

The communication control section 1008 transmits the sales report processing results encrypted with the communication key to the portable terminal 20 (Step S42). Thus, the display control section 2002 of the portable terminal 20 can display the execution result image 65 including the sales report processing results when the result display button 613 of the sales report processing selection image 61 is pressed.

The communication control section 2003 of the portable terminal 20 breaks the connection by the TCP or the like with the payment terminal 10 (Step S43). The communication control section 1008 of the payment terminal 10 breaks the connection by the TCP or the like with the portable terminal 20 (Step S44).

The communication control section 1008 of the payment terminal 10 deletes the communication key transmitted to the portable terminal 20 (Step S46). Through the above processing, the payment terminal 10 terminates the remote sales report processing.

The communication control section 2003 of the portable terminal 20 deletes the communication key received from the payment terminal 10 (Step S45). Through the above processing, the portable terminal 20 terminates the remote sales report processing.

As described above, the portable terminal 20 of the payment system 1 according to this embodiment acquires the sales report setting file 111 from the payment terminal 10, accepts the input of the data corresponding to an item specified by the sales report setting file 111, and transmits the input data as sales data to the payment terminal 10. The payment terminal 10 of the payment system 1 provides the sales report setting file 111 stored in the memory 103 to the portable terminal 20, and outputs the sales data received from the portable terminal 20 by, for example, transmitting it to the credit center server.

In such a manner, the portable terminal 20 can generate the sales data, in which the items suitable for the needs of the shopping center are totaled, on the basis of the sales report setting file 111 that specifies the totaling items according to the needs of the shopping center. In other words, the portable terminal 20 can generate sales data by remote operation and cause the payment terminal 10 to execute the processing of transmitting the sales data to the credit center server. Therefore, according to the payment system 1, the burden relating to the sales report processing can be reduced.

Note that the embodiment described above can also be appropriately modified and implemented by chancing some of the configurations or functions of the devices constituting the payment system 1. In this regard, some modifications according to the embodiment described above will be described below as other embodiments. Note that, in the following, the points that differ from the embodiment described above will be mainly described, and detailed description will be omitted for points that are common in those already described. Further, the modifications to be described below may be implemented individually or in combination as appropriate.

### Modification 1

In the embodiment described above, the form in which the sales report setting file 111 is acquired each time the sales report processing is executed has been described. In this modification, the form in which the sales report setting file 111 acquired by the portable terminal 20 is stored in the memory 203 will be described.

In this modification, the communication control section 2003 of the portable terminal 20 transmits a sales report setting file acquisition command to the payment terminal 10 when the sales report setting file 111 is not stored in the memory 203. The communication control section 2003 stores the sales report setting file 111 in the memory 203 when the sales report setting file 111 is received from the payment terminal 10.

Note that even if the sales report setting file 111 s stored in the memory 203, when the user gives an instruction or when the period exceeding a predetermined period has elapsed after the sales report setting file 111 is stored in the memory 203, the sales report setting file acquisition command may e transmitted to the payment terminal 10.

According to the modification, the processing of acquiring the sales report setting file 111 can be omitted, so that time taken for the sales report processing can be shortened.

### Modification 2

In the embodiment described above, the form in which the input of data corresponding to an item is accepted manually from the user has been described. In this modification, the form in which data corresponding to an item is automatically input on the basis of payment-related information indicating the sales relating to the transactions within a predetermined period will be described.

In this modification, the daily total processing section 1006 of the payment terminal 10 stores results of the daily total processing in the memory 103 after performing the daily total processing. The results of the daily total processing are examples of the payment-related information. Further, when the communication control section 1008 acquires the sales report setting file 111, the communication control section 1008 compares the item of the sales report setting file 111 with the results of the daily total processing stored in the memory 103.

As a result of the comparison, when there is data corresponding to the item of the sales report setting file 111 in the results of the daily total processing, the communication control section 1008 transmits to the portable terminal 20 automatically-input data in which the item and the data corresponding to that item are associated with each other, together with the sales report setting file 111.

When the automatically-input data is received from the payment terminal 10, the display control section 2002 of the portable terminal 20 displays an input image 63 of the item corresponding to the automatically-input data, with the data corresponding to the item being input in advance in the data input field.

Note that when there is data corresponding to the item of the sales report setting file 111 in the data that can be acquired from a point-of-sale (POS) terminal (not shown in the figure) connected to the payment terminal 10, such as totaling results of cash sales, the communication control section 1008 may acquire that data from the POS terminal. In this case, the communication control section 1008 is an example of a second acquisition section. Further, the communication control section 1008 may transmit that data associated with the corresponding item, as the automatically-input data, to the portable terminal 20.

According to this modification, since the data corresponding to an item is automatically input, it is possible to prevent input errors and shorten time taken for the sales report processing.

The programs executed by each device of the embodiment and modifications described above are provided by being pre-embedded in the storage medium (ROM or storage device) included in each device, but they are not limited thereto. For example, the programs executed by each device may be configured to be provided by being recorded on a computer-readable recording medium such as a CD-ROM, a flexible disk (FD), a CD-R, or a digital versatile disk (DVD) in an installable or executable format file. In addition, the storage medium is not limited to a medium that is independent from a computer or embedded system, and include a storage medium that downloads and then stores or temporality stores programs transmitted through a LAN, the Internet, or the like.

Further, the programs executed by each device of the embodiment and modifications described above may be configured to be provided by being stored in a computer connected to a network such as the Internet and by being downloaded via a network, or may be configured to be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A payment terminal operation system, comprising:
a payment terminal that is provided in a store and executes sales report processing of transmitting sales data obtained by totaling sales of the store to an external payment management system, the sales data being data of sales of the store totaled for each predetermined totaling item; and
an information processing apparatus that receives an input of the data of sales for each totaling item to remotely operate the sales report processing of the payment terminal, wherein
the payment terminal includes:
a first communication interface that executes communication with the information processing apparatus via a network;
a memory that stores setting information that specifies the totaling item; and
a first processor configured to
provide the setting information stored in the memory to the information processing apparatus via the first communication interface,
receive the sales data totaled on a basis of the provided setting information from the information processing apparatus via the first communication interface, and
output the received sales data to the payment management system via the first communication interface, and
the information processing apparatus includes:
a second communication interface that executes communication with the payment terminal via the network; and
a second processor configured to
acquire the setting information from the payment terminal via the second communication interface,
generate the sales data in the store in which the payment terminal is provided, on a basis of the setting information acquired from the payment terminal, and
transmit the generated sales data to the payment terminal via the second communication interface.

2. The payment terminal operation system according to claim 1, wherein
the information processing apparatus further includes a display device that displays various images, and
the second processor
causes the display device to display an input image for assisting an input of information relating to the totaling item, for each totaling item specified by the setting information, and
generates the sales data on a basis of information input via the input image.

3. The payment terminal operation system according to claim 1, wherein
the first processor
further stores, in the memory, payment-related information indicating sales relating to transactions within a predetermined period, and
transmits the payment-related information stored in the memory to the information processing apparatus via the first communication interface.

4. The payment terminal operation system according to claim 3, wherein
the second processor
acquires the payment-related information from the payment terminal via the second communication interface, and
generates the sales data on a basis of the acquired setting information and the acquired payment-related information.

5. The payment terminal operation system according to claim 4, wherein
the first processor
acquires payment-related information corresponding to the totaling item specified by the setting information, and
provides the acquired payment-related information corresponding to the totaling item together with the setting information to the information processing apparatus via the first communication interface.

6. A payment terminal that is provided in a store and executes sales report processing of transmitting sales data to an external payment management system, the sales data being data of sales of the store totaled for each predetermined totaling item, comprising:
a communication interface that executes communication with an information processing apparatus via a network and receives an input of the data of sales for each totaling item to remotely operate the sales report processing of the payment terminal;
a memory that stores setting information that specifies the totaling item; and
a processor configured to
provide the setting information stored in the memory to the information processing apparatus via the communication interface,
receive the sales data totaled on a basis of the provided setting information from the information processing apparatus via the communication interface, and
output the received sales s data to the payment management system via the communication interface.

7. The payment terminal according to claim 6, wherein
the processor
further stores, in the memory, payment-related information indicating sales relating to transactions within a predetermined period, and
transmits the payment-related information stored in the memory to the information processing apparatus via the communication interface.

8. The payment terminal according to claim 7, wherein
the processor
acquires the payment-related information corresponding to the totaling item specified by the setting information, and
provides the acquired payment-related information corresponding to the totaling item together with the setting information to the information processing apparatus via the communication interface.

9. An information processing apparatus that receives an input of data of sales for each totaling item to remotely operate a payment terminal that is provided in a store and executes sales report processing of transmitting sales data to an external payment management system, the sales data in the being data of sales store totaled for each predetermined totaling item, comprising:
a communication interface that executes communication with the payment terminal via a network; and
a processor configured to
acquire setting information from the payment terminal via the communication interface, the setting information being information that specifies the totaling item,
generate the sales data in the store in which the payment terminal is provided, on a basis of the setting information acquired from the payment terminal, and
transmit the generated sales data to the payment terminal via the communication interface.

10. The information processing apparatus according to claim 9, further comprising
a display device that displays various images, wherein the processor
causes the display device to display an input image for assisting an input of information relating to the totaling item, for each totaling item specified by the setting information, and
generates the sales data on a basis of information input via the input image.
